(19) United States
(12) Patent Application Publication
(10) Pub. No.: US 2011/0107653 A1
(43) Pub. Date: May 12, 2011

(54) Hidden Fishhook Structure Having a Fish Shape

(76) Inventor: Tsung-Hsi TSAI, Changhua City (TW)

(21) Appl. No.: 12/243,544

(22) Filed: Oct. 1, 2008

(51) Int. Cl. A01K 85/02

(52) U.S. Cl. 43/35

(57) ABSTRACT

A hidden fishhook structure having a fish shape includes an extendable device, two limiting boards, two engaging boards, and two semi-fish bodies. The extendable device is placed in between the two limiting boards. The two limiting boards are placed in between the two engaging boards. The two engaging boards are placed in between the semi-fish bodies to form a false fish for attracting fish. When a rear fish is hooked, a dragging board of the extendable device will be pulled outwards. Due to the confinement of a limiting recess, an elastic member, connecting rods and a hook member are linked to drive the hook member to extend and slide. A hook of the hook member is exposed from an extending opening to hook the mouth of the real fish securely. By the elasticity of the elastic member, this hidden fishhook structure is capable of re-use and safety.

### BACKGROUND OF THE INVENTION

1. Field of the Invention

The present invention relates to a hidden fishhook structure having a fish shape, and more particularly to an extendable device hidden in a colored false fish to attract real fish. When a rear fish is hooked, a dragging board will be pulled outwards. Due to the confinement of a limiting recess, an elastic member, connecting rods and a hook member are linked to drive the hook member to extend and slide. A hook of the hook member is exposed from an extending opening to hook the mouth of the real fish securely. By the elasticity of the elastic member, this hidden fishhook structure is capable of re-use and safety.

2. Description of the Prior Art

A false fish is used to be an auxiliary tool for fishing. The false fish is brightly colored to swing in the water and to attract real fish. The false fish is provided with one or more hooks. The hook is provided with feed for attracting fish to be hooked. There are some shortcomings existed in a conventional fishhook.

1. The one or more hooks provided on the false fish may block the outside of the false fish, in particular, the feed hooked on the hooks. This influences the effect of attracting fish.
2. The one or more hooks provided on the false fish may hook other objects in the water. It is necessary to pull up the false fish and clean out the objects.

Accordingly, the inventor of the present invention has devoted himself based on his many years of practical experiences to the development of a hidden fishhook structure having a fish shape for re-use and safety.

### SUMMARY OF THE INVENTION

According to the present invention, there is provided a hidden fishhook structure having a fish shape, comprising:

an extendable device comprising a dragging board, an elastic member, a pair of connecting rods, a hook member, a shaft, and a pair of pivots, the dragging board having a ring at one end, a slot at a middle section, a first hole at another end, and a protruding bit formed at an inner side of the slot, the connecting rods each having two second holes at respective ends thereof, the two connecting rods being pivotally connected to the dragging board and the hook member respectively, with the pair of pivots inserting through the first hole, the second holes and a third hole of the hook member, the hook member having a hook at an upper end, the third hole at a lower end, and a supporting rod with a fourth hole extending from one side thereof, the fourth hole being adapted for insertion of the shaft;

two limiting boards each having a limiting recess at a central portion, a first notch at a front end, a limiting opening at a rear end, a stopper extending from an inner side at a front section, a limiting rod and a shaft trough at a middle section thereof;

two engaging boards each having an engaging recess at a front section, a second notch at a front end, and an extending opening at a rear end thereof;

two semi-fish bodies each having an accommodation corresponding in shape to the engaging boards and a rightly colored outside;

thereby, the extendable device being placed in between the two limiting boards, the two limiting boards being placed in between the two engaging boards, the two engaging boards being placed in between the semi-fish bodies to form a false fish for attracting fish, when a real fish is hooked, the false fish being pulled to facilitate the dragging board extending outwards from the second notch by a fishing line, the two connecting rods and the elastic member being linked to drive the hook member, the hook member being extended and flipped out from the extending opening, with the shaft as an axis and the supporting rod as a rotating arm, to hook the mouth of the real fish, by the elasticity of the elastic member, the hidden fishhook structure being capable of re-use and safety.

### BRIEF DESCRIPTION OF THE DRAWINGS

FIG. 1 is an exploded view according to a preferred embodiment of the present invention;

FIG. 2 is an exploded view of an extendable device according to the preferred embodiment of the present invention;

FIG. 3 is a perspective view according to the preferred embodiment of the present invention;

FIG. 4-A is a cross-sectional view according to the first preferred embodiment of the present invention in an extended status; and

FIG. 4-B is a cross-sectional view according to the first preferred embodiment of the present invention in a retracted status.

### DETAILED DESCRIPTION OF THE PREFERRED EMBODIMENT

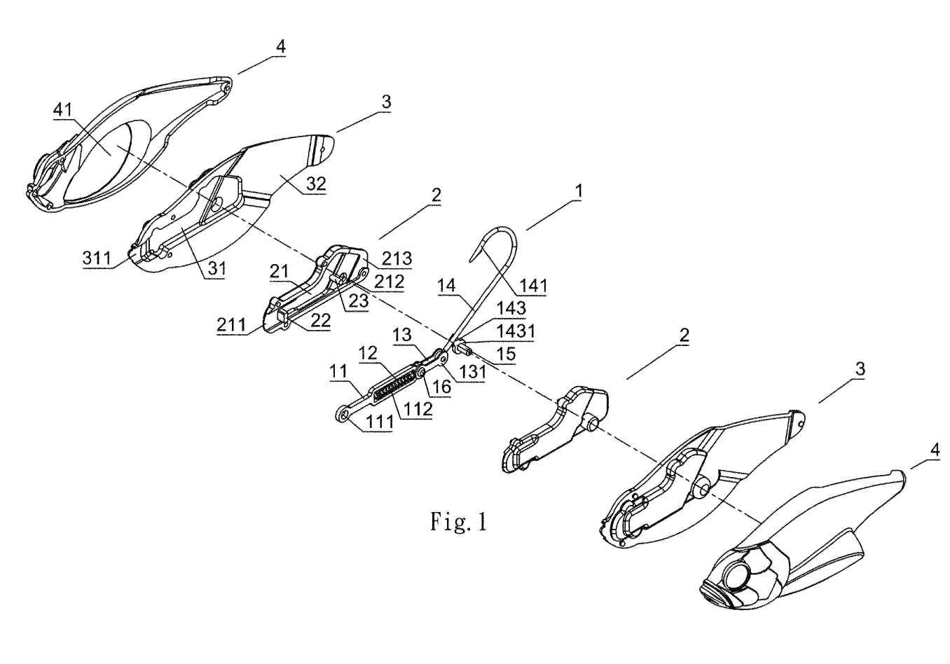

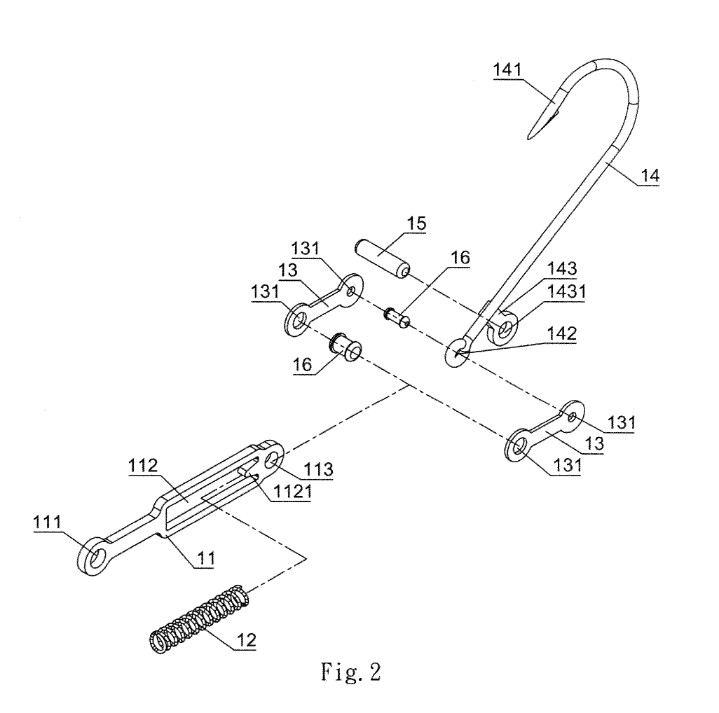

As shown in FIGS. 1 and 2, a preferred embodiment of the present invention comprises an extendable device 1, two limiting boards 2, two engaging boards 3, and two semi-fish bodies 4.

The extendable device 1 comprises a dragging board 11, an elastic member 12, a pair of connecting rods 13, a hook member 14, a shaft 15, and a pair of pivots 16. The dragging board 11 has a ring 111 at one end, a slot 112 at a middle section, a first hole 113 at the other end, and a protruding bit 1121 formed at an inner side of the slot 112. One end of the elastic member 12 fits onto the protruding bit 1121. The elastic member 12 may be a spring. Each of the connecting rods 13 has two second holes 131 at respective ends thereof. The two connecting rods 13 are pivotally connected to the dragging board 11 and the hook member 14, respectively, with the pair of pivots 16 inserting through the first hole 113, the second holes 131 and a third hole 142 of the hook member 14. The hook member 14 has a hook 141 at an upper end, the third hole 142 at a lower end, and a supporting rod 143 with a fourth hole 1431 extending from one side thereof.

Each of the limiting boards 2 has a limiting recess 21 at a central portion, a first notch 211 at a front end, a limiting opening 213 at a rear end, a stopper 22 extending from an inner side at a front section, a limiting rod 23 and a shaft trough 212 at a middle section thereof. The extendable device 1 is disposed in the recess 21, with the dragging board 11 extending outward from the notch 211 and the hook member 14 extending outward from the limiting opening 213. The stopper 22 extends into the slot 112 to hold against the other end of the elastic member 12. The liming rod 23 is adapted to limit the hook member 14 when the hook member 14 is extended. The shaft trough 212 is for insertion of the shaft 15.

Each of the engaging boards 3 has an engaging recess 31 at a front section, a second notch 311 at a front end, and an extending opening 32 at a rear end thereof. The engaging recess 31 is adapted to accommodate the limiting board 2. The second notch 311 is flush with the first notch 211. The extending opening 32 is adapted to hide the hook member 14.

Each of the semi-fish bodies 4 has an accommodation 41 corresponding in shape to the limiting boards 3. The outside of each semi-fish body 4 is brightly colored to attract fish.

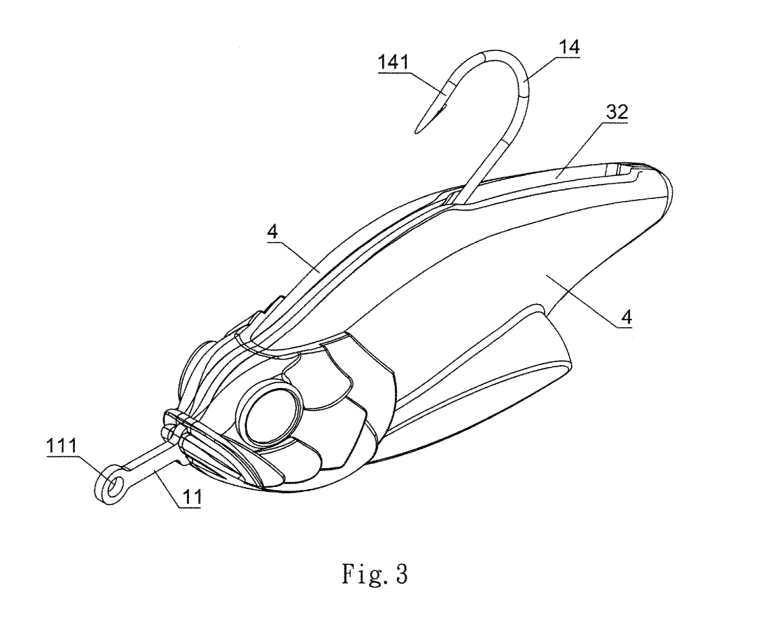

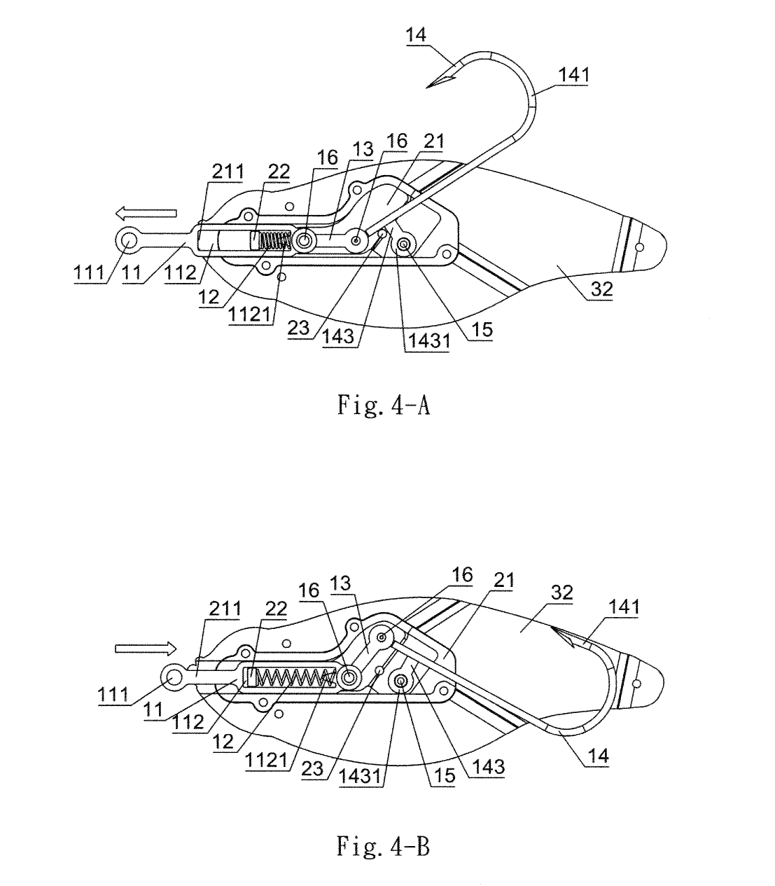

As shown in FIGS. 3, 4-A and 4-B, a fishing line is tied to the ring 111 extending outward from the second notch 311. The extendable device 1 is hidden and disposed in the semi-fish bodies 4 like a real fish swinging in the water. When a real fish is hooked, the dragging board 11 will be pulled forward and the elastic member 12 will be compressed by the protruding bit 1121 and blocked by the stopper 22. One end of the connecting rod 31 is pulled forward because of the confinement by the limiting recess 21, while the other end of the connecting rod 31 is moved downward because the shaft 15 is inserted through the fourth hole 1431 and confined by the shaft trough 212. The hook 141 is extended and flipped out from the extending opening 32, with the shaft 15 as an axis and the supporting rod 143 as a rotating arm. The limiting rod 22 engages with the joint of the hook member 14 and the supporting rod 143 to slow down the extension of the hook member 14, as shown in FIG. 4-A. The hook 141 is able to hook the fish securely. After taking off the real fish, the extendable device 1 will return to its original position, as shown in FIG. 4-B, due to the elasticity of the elastic member 12. This design provides safety when the present invention is not in use and is able to hook fish exactly when in use.

By the extendable device 1 hidden in the semi-fish bodies 4 and the fishing line tied to the ring 111, when the semi-fish bodies 4 are pulled by the real fish, the extendable device 1 will be linked to extend and slide. This is to hook the mouth of the real fish securely. When the present invention is not in use, the hook member 14 is able to be retraced in the semi-fish bodies 4 for the reason of safety.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hidden fishhook structure having a fish shape, comprising:
an extendable device comprising a dragging board, an elastic member, a pair of connecting rods, a hook member, a shaft, and a pair of pivots, the dragging board having a ring at one end, a slot at a middle section, a first hole at another end, and a protruding bit formed at an inner side of the slot, the connecting rods each having two second holes at respective ends thereof, the two connecting rods being pivotally connected to the dragging board and the hook member respectively, with the pair of pivots inserting through the first hole, o the second holes and a third hole of the hook member, the hook member having a hook at an upper end, the third hole at a lower end, and a supporting rod with a fourth hole extending from one side thereof, the fourth hole being adapted for insertion of the shaft;
two limiting boards each having a limiting recess at a central portion, a first notch at a front end, a limiting opening at a rear end, a stopper extending from an inner side at a front section, a limiting rod and a shaft trough at a middle section thereof;
two engaging boards each having an engaging recess at a front section, a second notch at a front end, and an extending opening at a rear end thereof;
two semi-fish bodies each having an accommodation corresponding in shape to the engaging boards and a rightly colored outside;
thereby, the extendable device being placed in between the two limiting boards, the two limiting boards being placed in between the two engaging boards, the two engaging boards being placed in between the semi-fish bodies to form a false fish for attracting fish, when a real fish is hooked, the false fish being pulled to facilitate the dragging board extending outwards from the second notch by a fishing line, the two connecting rods and the elastic member being linked to drive the hook member, the hook member being extended and flipped out from the extending opening, with the shaft as an axis and the supporting rod as a rotating arm, to hook the mouth of the real fish, by the elasticity of the elastic member, the hidden fishhook structure being capable of re-use and safety.

2. The hidden fishhook structure having a fish shape as claimed in claim 1, wherein the elastic member is a spring.
